(19) United States
(12) Patent Application Publication
(10) Pub. No.: US 2007/0114758 A1
(43) Pub. Date: May 24, 2007

(54) KINGPIN STABILIZER

(75) Inventor: Bernard F. Garceau, Vandalia, MI (US)

Correspondence Address: HAHN LOESER & PARKS, LLP, One GOJO Plaza, Suite 300, AKRON, OH, 44311-1076, US

(73) Assignee: NORCO INDUSTRIES, INC., Compton, CA (US)

(21) Appl. No.: 11/562,478

(22) Filed: Nov. 22, 2006

Related U.S. Application Data
(60) Provisional application No. 60/597,305, filed on Nov. 22, 2005.

(51) Int. Cl. B62D 53/06

(52) U.S. Cl. 280/425.2

(57) ABSTRACT

A pair of telescopic tensioning legs are pivotally attached to either a fifth wheel trailer goose-neck or kingpin. To stabilize the trailer, the telescopic tensioning legs are extended between the trailer gooseneck and the trailer extension supports foot pads.

This application claims priority from U.S. application Ser. No. 60/597,305, filed Nov. 22, 2005, hereby incorporated by reference.

### BACKGROUND OF THE INVENTION

This invention relates generally to trailer stabilizers and more particularly to stabilizers for a gooseneck or kingpin.

Various types of recreational vehicles and trailers require supporting and stabilizing in a safe and secure position after the recreational vehicle or trailer has been detached from the cab or truck which had been towing the vehicle or trailer.

A vehicle which is constructed to be towed, such as a fifth wheel recreational vehicle, or a camper, or a trailer, conventionally includes an upper portion, or gooseneck portion that extends forwardly a considerable distance at the front of the vehicle. The typical front extension section is constructed to avoid interference with the body members of the towing truck or cab while moving and turning, and the front extension section of the vehicle or trailer includes means for connecting the vehicle to the towing truck or cab.

Thus, the front section extends in an unsupported and possibly unbalanced condition when the recreational vehicle or trailer is detached from the towing truck or cab.

Quite often, the front extension section of a recreational vehicle is designed to incorporate a form of sleeping area or storage space. With this design, the front section may become unstable and be in need of further support when the recreational vehicle is separated from the towing truck.

The normal means for temporarily connecting a recreational vehicle or trailer to a towing truck comprises a pivotal apparatus, generally including a kingpin secured beneath the front extension portion of the vehicle in cooperation with a form of socket secured on the body of the truck. In this arrangement, the connective device on the recreational vehicle is referred to as a fifth wheel.

Usually, the recreational vehicle or trailer includes a pair of short extension supports beneath the main body of the vehicle and at the very front of the main body and behind the front extension portion of the vehicle, which are lowered into a supporting position to the surface of the ground when the operator is preparing to remove the vehicle from the attachment to the towing truck.

Unfortunately, these typical extension supports do not provide sufficient stabilization of the front of the fifth wheel travel trailer.

The foregoing illustrates limitations known to exist in present trailer stabilizers. Thus, it is apparent that it would be advantageous to provide an alternative directed to overcoming one or more of the limitations set forth above. Accordingly, a suitable alternative is provided including features more fully disclosed hereinafter.

### SUMMARY OF THE INVENTION

In one aspect, a kingpin stabilizer is described comprising telescopic tension legs that extend from either the trailer gooseneck or the trailer kingpin to base pads on the trailer corner supports.

In a further aspect, a kingpin stabilizer is described comprising telescopic tension legs that are pivotally attached to the trailer gooseneck that can be moved between a raised travel position and a lowered stabilizing position.

The foregoing and other aspects will become apparent from the following detailed description of the invention when considered in conjunction with the accompanying drawing figures.

### BRIEF DESCRIPTION OF THE DRAWING FIGURES

FIG. 1 is a perspective view illustrating the kingpin stabilizer in the lowered position attached to the gooseneck in the lowered position;

FIG. 2 is a second perspective view illustrating the kingpin stabilizer in the raised or travel position;

FIG. 3 is a perspective view of the kingpin stabilizer illustrating the pivot ball attached to the gooseneck and the storage bracket attached to the trailer;

FIG. 4 is a perspective view illustrating a telescopic tensioning leg of the kingpin stabilizer; and

FIG. 5 is a schematic view of a portion of a trailer illustrating the kingpin stabilizer attached to the kingpin.

### DETAILED DESCRIPTION

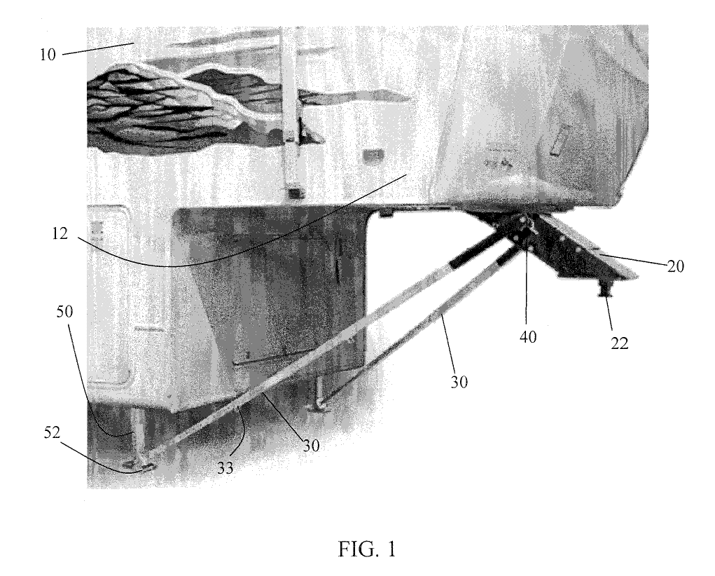

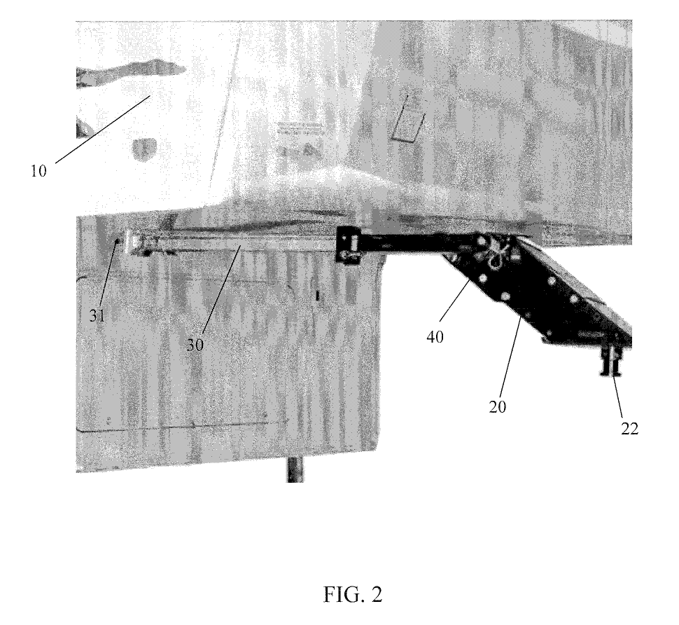

Shown in FIGS. 1 and 2 is a fifth wheel travel trailer 10 having a front extension 12 extending from the front of the trailer 10. Typically, the trailer front extension 12 is a bedroom. Attached to the underside of the trailer front extension 12 is a gooseneck 20 that has a kingpin 22 attached to its underside. The kingpin 22 is used to connect the trailer 10 to the towing vehicle (not shown).

Trailer 10 includes support extensions 50, usually one near each corner of the trailer 10. After the trailer 10 has been positioned in its assigned camping space, the support extensions 50 are lowered to the ground to level and support the trailer 10. Each support extension usually includes a foot pad 52 to provide greater contact with the ground.

The kingpin stabilizer comprises a pair of telescopic tension legs 30 that extend from either the gooseneck 20 or the kingpin 22 to the trailer support extension foot pads 52.

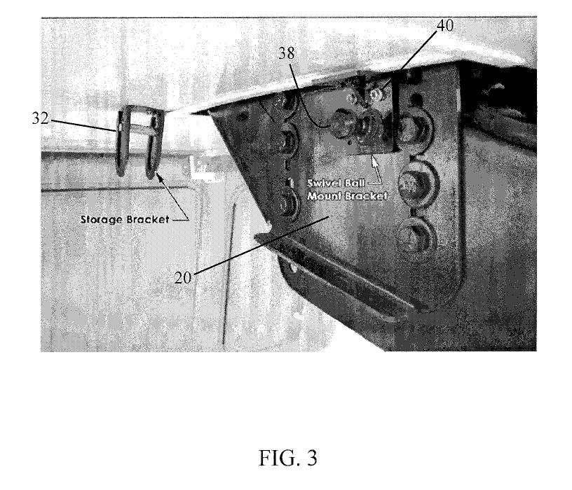

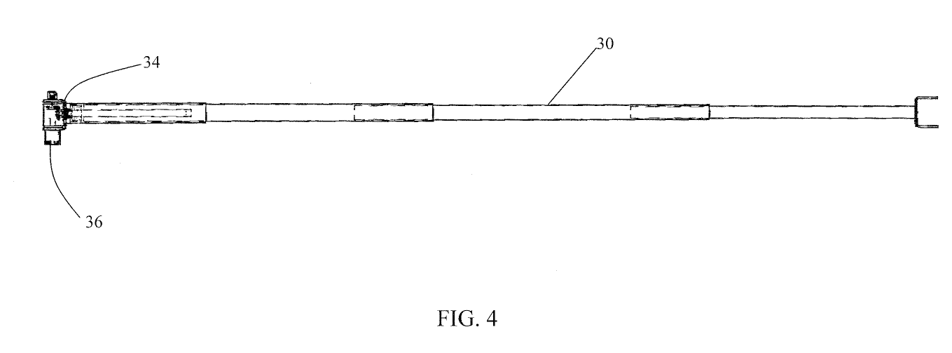

The telescopic tension legs 30 are pivotally attached at 40 to the gooseneck 20 to allow legs 30 to move between a raised travel position, shown in FIG. 2, to a lowered stabilizing position, shown in FIG. 1. Further in this embodiment, each telescopic tension leg 30 is provided with a pivot socket 36, which receives a pivot ball 38 attached to either the gooseneck 20 or kingpin 22, FIGS. 3 and 4. The pivot socket 36 is secured to the pivot ball 38 by a retaining pin (not shown). The pivot socket 36 and pivot ball 38 permit the legs 30 to pivot in a first plane parallel to the length of the trailer 10 and to swivel in a second plane perpendicular to the length of the trailer 10, i.e. polar motion. In a further embodiment, the telescopic tension legs 30 also swivel to permit the ends of the legs 30 to be positioned further inboard of the side of trailer 10 when the legs 30 are in the raised travel position.

The legs 30 may include a tensioning device to provide tension between the trailer front extension 12, via the gooseneck 20, and the support extension foot pads 52. Shown in FIG. 4, the tensioning device is a jack screw 34 disposed in one end of the leg 30.

Also, a storage bracket 32 may be provided in combination with retaining pins 31 on the trailer 10 to hold the telescopic tension legs 30 in the raised travel position, shown in FIG. 3.

After the trailer 10 has been positioned in its assigned camping space, and the towing vehicle has been disconnected from the trailer 10, the trailer 10 is leveled and stabilized using the support extensions 50. Next, the telescopic tension legs 30 are released from the raised travel position by releasing the legs 30 from the storage bracket 32. The telescopic tension legs 30 comprise multiple sections that fit within one another and the bottommost sections of the legs 30 contain multiple adjustment holes, shown in FIG. 1. A retaining pin 33 used to secure each of the telescopic tension legs 30 in a retracted position is removed from each of the legs 30, and the legs 30 are pivoted downward, outward and telescopically extended until the free ends of the legs 30 fit onto the support extension foot pads 52. As shown in FIG. 1, the legs 30 are attached to the foot pads 52 by tension, but a mechanical attachment, for example a retaining pin, may also be used. The legs 30 may attach to the foot pads 52 at a variety of angles, depending on how far the support extensions 50 are extended to level the trailer 10. Once the legs 30 are fully extended and attached to the foot pads 52, a retaining pin 33 is reinserted into each leg 30 to secure the legs 30 in an extended position. Finally, the jack screw 34 or other telescoping mechanism is operated to apply tension between the gooseneck 20 and the foot pad 52.

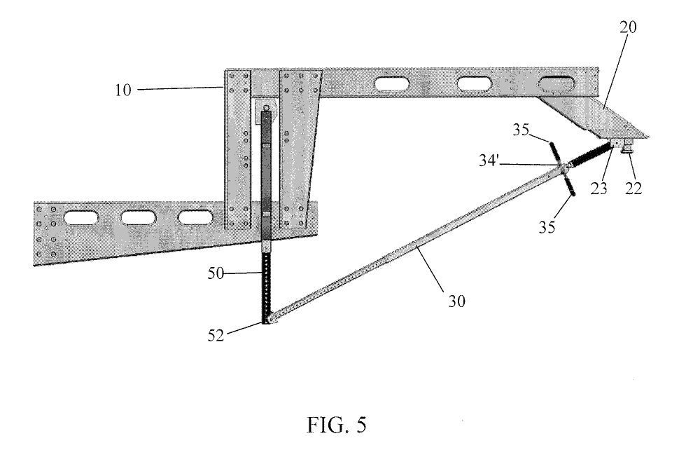

In an alternate embodiment, shown in FIG. 5, the telescopic tension legs 30 are pivotally removably attached to a kingpin collar bracket 23 by retaining pins (not shown). Further this embodiment, the tensioning device is a screw drive assembly 34′. Tension is increased between the support extension foot pads 52 and the kingpin 22 by rotating the screw drive assembly handles 35.

Having described the invention, what is claimed is:

1. A kingpin stabilizer comprising telescopic tension legs extending between a trailer gooseneck and trailer support extension foot pads.

2. The kingpin stabilizer according to claim 1, wherein each telescopic tension leg is pivotally attached to the trailer gooseneck, the telescopic tension legs having a first position wherein the legs are secured to the trailer in a raised position by a storage bracket and a second position wherein the telescopic tension legs are attached to the trailer support extension foot pads in a lowered stabilizing position.

3. The kingpin stabilizer according to claim 1, wherein each telescopic tension leg includes a tensioning device.

4. The kingpin stabilizer according to claim 3, wherein the tensioning device is a jack screw.

5. The kingpin stabilizer according to claim 2, further comprising a ball and socket joint attaching each telescopic tension leg to the trailer gooseneck.

6. The kingpin stabilizer according to claim 5, wherein the telescopic tension legs pivot in a plane parallel to the length of the trailer and swivel in a plane perpendicular to the length of the trailer.

7. The kingpin stabilizer according to claim 2, wherein the telescopic tension legs can be attached to the trailer support extension foot pads at a plurality of angles.

8. The kingpin stabilizer according to claim 1, wherein the telescopic tension legs extend between a trailer kingpin and trailer support extension foot pads.

9. The kingpin stabilizer according to claim 8, wherein the telescopic tension legs are removably attached to the kingpin.

10. The kingpin stabilizer according to claim 9, wherein the telescopic tension legs are removably attached to a kingpin collar bracket disposed about the kingpin.

11. The kingpin stabilizer according to claim 8, wherein each telescopic tension leg includes a tensioning device.

12. In combination;
a trailer, the trailer including a gooseneck, a kingpin, support extensions, and support extension foot pads; and
a kingpin stabilizer, the kingpin stabilizer comprising telescopic tension legs extending between the trailer gooseneck and the trailer support extension foot pads.

13. The combination according to claim 12, wherein each telescopic tension leg is pivotally attached to the trailer gooseneck, the telescopic tension legs having a first position wherein the legs are secured to the trailer in a raised position by a storage bracket and a second position wherein the telescopic tension legs are attached to the trailer support extension foot pads in a lowered, extended position.

14. The combination according to claim 12, wherein each telescopic tension leg includes a tensioning device.

15. The combination according to claim 14, wherein the tensioning device is a jack screw.

16. The combination according to claim 13, further comprising a ball and socket joint attaching each telescopic tension leg to the trailer gooseneck.

17. The combination according to claim 16, wherein the telescopic tension legs pivot in a plane parallel to the length of the trailer and swivel in a plane perpendicular to the length of the trailer.

18. The combination according to claim 13, wherein the telescopic tension legs can be attached to the trailer support extension foot pads at a plurality of angles.

19. The method of supporting a trailer comprising:
providing a kingpin stabilizer, the kingpin stabilizer comprising telescopic tension legs pivotally attached to a trailer gooseneck, the kingpin stabilizer having a first position wherein the legs are secured to the trailer by a storage bracket and a second position wherein the legs are attached to trailer support extension foot pads;
pivoting the legs downward, outward and telescopically extending the legs from the first position to the second position;
attaching the legs to the support extension foot pads; and
tensioning the legs between the trailer gooseneck and the support extension foot pads.
